(19) United States
(12) Patent Application Publication
(10) Pub. No.: US 2026/0187823 A1
(43) Pub. Date: Jul. 2, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: YASUHIRO SUTOU, TOKYO (JP)

(21) Appl. No.: 18/865,050

(22) PCT Filed: Apr. 6, 2023
(86) PCT No.: PCT/JP2023/014222

§ 371 Date: Nov. 12, 2024

(30) Foreign Application Priority Data
May 20, 2022 (JP) 2022-082796

(51) Int. Cl. G06T 7/269; G06F 3/01; G06T 7/00; G06V 40/20

(52) U.S. Cl. CPC G06T 7/269; G06F 3/017; G06T 7/97; G06V 40/28; G06T 2207/10016; G06T 2207/10024; G06T 2207/30196

(57) ABSTRACT

[Problem] Low-latency, high-accuracy object tracking is achieved.

[Means of Solution] An information processing device is provided, including a tracking processing unit that detects and tracks a target object based on a first image and a second image that are acquired in a time series, wherein the tracking processing unit detects the target object based on the first image, calculates an amount of motion of the target object based on a spatial gradient derived from the first image and a temporal gradient derived from the second image, and tracks the target object based on the amount of motion, and the second image is acquired at a frame rate higher than a frame rate of the first image.

### TECHNICAL FIELD

The present disclosure relates to an information processing device, an information processing method, and a program.

### BACKGROUND ART

In recent years, technology has been developed for tracking the position of a target object in images captured in a time series. For example, PTL 1 discloses an object tracking technology using the Lucas-Kanade method (hereinafter referred to as the LK method).

### CITATION LIST

### Patent Literature

### [PTL 1]

JP 2011-233039A

### SUMMARY

### Technical Problem

The speed of the tracking processing as disclosed in PTL 1 depends heavily on the frame rate of the images.

### Solution to Problem

According to an aspect of the present disclosure, an information processing device is provided, including a tracking processing unit that detects and tracks a target object based on a first image and a second image that are acquired in a time series, wherein the tracking processing unit detects the target object based on the first image, calculates an amount of motion of the target object based on a spatial gradient derived from the first image and a temporal gradient derived from the second image, and tracks the target object based on the amount of motion, and the second image is acquired at a frame rate higher than a frame rate of the first image.

According to another aspect of the present disclosure, an information processing method is provided, including detecting and tracking, by a processor, a target object based on a first image and a second image that are acquired in a time series, wherein the tracking further includes detecting the target object based on the first image, calculating an amount of motion of the target object based on a spatial gradient derived from the first image and a temporal gradient derived from the second image, and tracking the target object based on the amount of motion, and the second image is acquired at a frame rate higher than a frame rate of the first image.

According to another aspect of the present disclosure, a program is provided, causing a computer to function as an information processing device including a tracking processing unit that detects and tracks a target object based on a first image and a second image that are acquired in a time series, wherein the tracking processing unit detects the target object based on the first image, calculates an amount of motion of the target object based on a spatial gradient derived from the first image and a temporal gradient derived from the second image, and tracks the target object based on the amount of motion, and the second image is acquired at a frame rate higher than a frame rate of the first image.

### BRIEF DESCRIPTION OF DRAWINGS

FIG. 1 is a diagram illustrating a schematic flow of tracking processing according to an embodiment of the present disclosure.

FIG. 2 is a diagram schematically illustrating a motion amount calculation using an approximate image 13 according to the embodiment.

FIG. 3 is a block diagram illustrating a functional configuration example of an information processing device 10 according to the embodiment.

FIG. 4 is a diagram for explaining an overview of time-series image processing according to the embodiment.

FIG. 5 is a flowchart illustrating an example of a flow of tracking processing according to the embodiment.

FIG. 6 is a flowchart illustrating an example of a flow of learning according to the embodiment.

FIG. 7 is a diagram for explaining a configuration in the case where a result of the tracking processing according to the embodiment is used for gesture analysis in an NUI.

FIG. 8 is a diagram for explaining a configuration in the case where a result of the tracking processing according to the embodiment is used for calculation of parameters for the acquisition of an RGB image 11.

FIG. 9 is a diagram for explaining a structure of a 2-in-1 sensor 160 according to the embodiment.

FIG. 10 is a block diagram illustrating an exemplary hardware configuration of an information processing device 90 according to the embodiment.

FIG. 11 is a diagram illustrating an example of a flow of LK method-based tracking processing using RGB images.

### DESCRIPTION OF EMBODIMENTS

Preferred embodiments of the present disclosure will be described below in detail with reference to the accompanying figures. In the present specification and drawings, components having substantially the same functional configuration will be denoted by the same reference numerals, and thus repeated descriptions thereof will be omitted.

The description will be given in the following order.
1. Embodiment
1.1. Overview
1.2. Functional Configuration Example of Information Processing Device 10
1.3. Details of Tracking Processing
1.4. Details of Learning
1.5. Application Examples
1.6. Modification Example of Sensor
2. Hardware Configuration Example
3. Conclusion

### 1. EMBODIMENT

### 1.1. Overview

As described above, in recent years, technologies have been developed for tracking the position of a target object in images captured in a time series. An example of such an image is an RGB image.

In a typical tracking method using RGB images, a target object is tracked by calculating the motion of each pixel between frames.

However, a flow of typical tracking processing involves image acquisition, motion detection, and tracking in that order, which results in a delay of one or more frames. For example, each RGB image being acquired at 60 FPS results in a delay of 1/60 seconds or more.

Such a delay may be unacceptable depending on the nature of the application in which the tracking results are used.

For example, in a use case where a target object such as a hand of the user moves significantly in front of an RGB camera, such as a natural user interface (NUI) that supports gesture input, it is expected that the resulting RGB image will change significantly in 1/60 of a second due to focus loss, changes in the position of the target object, and the like. In this case, the tracking accuracy may be significantly reduced or tracking may fail.

Meanwhile, in recent years, tracking technology using an event-based vision sensor (EVS) has also been developed. The EVS is a vision sensor that detects changes in the brightness of each pixel, combines data corresponding to the changes in brightness with coordinates and time information, and outputs the resulting data, thereby achieving high-speed, low latency data output.

However, since the signal output by the EVS has three values, “+1”, “0”, and “−1”, such possible values may make it difficult for matching in the time direction.

For this reason, there are some cases where data is integrated in the time direction to create pseudo multi-tone image data, and tracking processing is performed based on that image data.

In this case, however, the high-speed responsiveness of the EVS is sacrificed. In addition, the pseudo image data as described above has more noise than a typical RGB image, and therefore, the accuracy of the motion calculation may be reduced.

A technical idea according to an embodiment of the present disclosure has been conceived in light of the above points, and achieves low latency, high-accuracy object tracking.

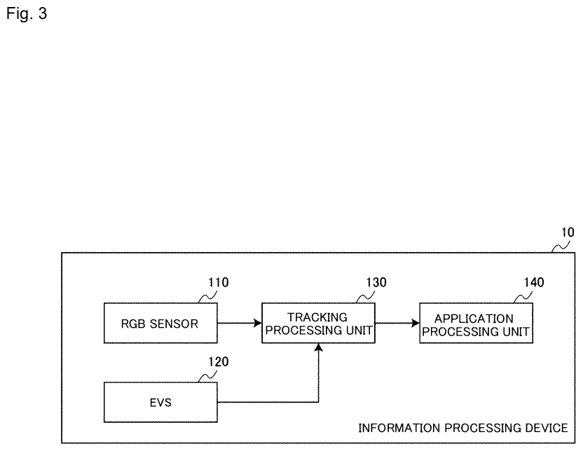

To this end, an information processing device 10 according to the embodiment of the present disclosure includes a tracking processing unit 130 (see FIG. 3) that detects and tracks a target object based on a first image and a second image that are acquired in a time series.

The tracking processing unit 130 according to the embodiment of the present disclosure has one feature that detects the target object based on the first image, calculates an amount of motion of the target object based on a spatial gradient derived from the first image and a temporal gradient derived from the second image, and tracks the target object based on the amount of motion.

Another feature is that the second image is acquired at a frame rate higher than a frame rate of the first image.

In addition, the first image may be an image with lower noise than the second image, that is, an image suitable for object detection or the like.

The first image according to the present embodiment may be, for example, an RGB image acquired by an RGB sensor.

The second image according to the present embodiment may be, for example, an EVS image acquired by an EVS.

In order to explain effects of an information processing method according to the present embodiment, first, LK method-based tracking processing using RGB images will be described.

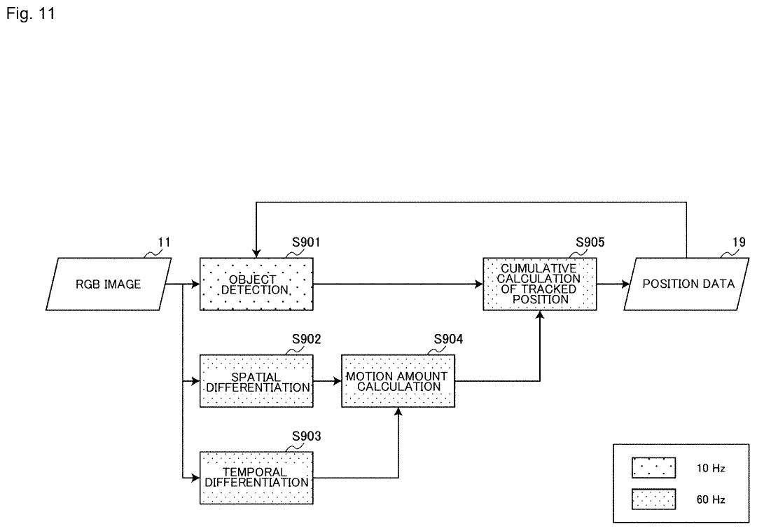

FIG. 11 is a diagram illustrating an example of a flow of LK method-based tracking processing using RGB images.

In the example illustrated in FIG. 11, first, an RGB image 11 is acquired by an RGB camera. The frame rate of the RGB image 11 is herein set to 60 Hz.

Next, a target object is detected based on the acquired RGB image 11 (S901). The target object detection in step S901 may be performed at a rate of, for example, about 10 Hz.

In addition, spatial differentiation (S902) and temporal differentiation (S903) are performed based on the acquired RGB image.

Next, an amount of motion is calculated based on a spatial gradient obtained by the spatial differentiation in step S902 and a temporal gradient obtained by the temporal differentiation in step S903 (amount of motion=temporal gradient/spatial gradient) (S904).

Next, based on the result of the target object detection in step S901 and the result of the motion amount calculation in step S904 (S905), a cumulative calculation of tracked position is performed, and position data 19 after tracking is output. The position data 19 is used to detect the next target object in step S901.

The speed of the spatial differentiation in step S902, the temporal differentiation in step S903, the motion amount calculation in step S904, and the tracking processing in step S905 depends on the frame rate (60 Hz) of the RGB image 11 as illustrated.

Therefore, for the method illustrated in FIG. 11, when the RGB image 11 has a large change, for example, when the motion of the target object is large, there is a possibility that the target object will be lost and the tracking will fail accordingly.

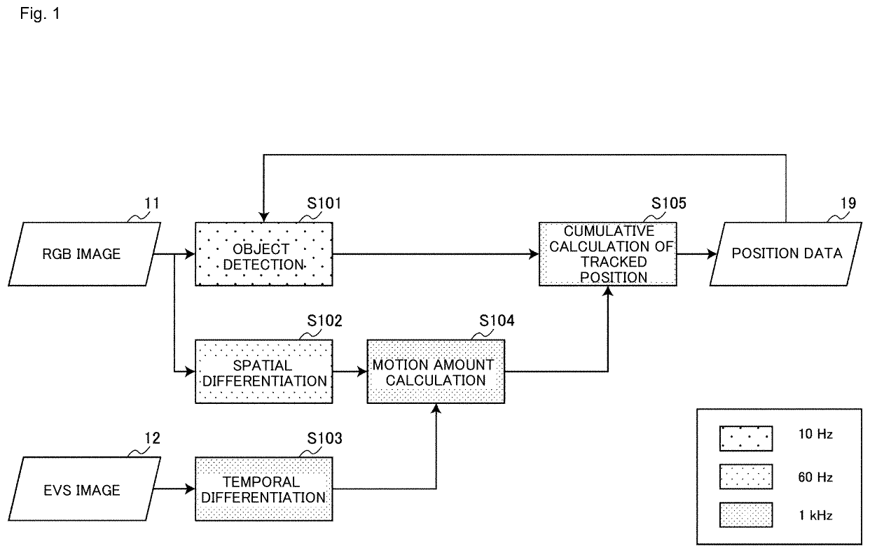

On the other hand, FIG. 1 is a diagram illustrating a schematic flow of the tracking processing according to the embodiment of the present disclosure.

In the tracking processing according to the present embodiment, first, an RGB image 11 is acquired by an RGB sensor 110 (see FIG. 3), and an EVS image 12 is acquired by an EVS 120 (see FIG. 3). The frame rate of the RGB image 11 is 60 Hz, and the frame rate of the EVS image is 1 kHz herein.

A tracking processing unit 130 according to the present embodiment performs target object detection (S101) and spatial differentiation (S102) based on the RGB image 11, similar to the method illustrated in FIG. 11.

On the other hand, unlike the method illustrated in FIG. 11, the tracking processing unit 130 according to the present embodiment performs temporal differentiation based on the EVS image 12 (S103).

The tracking processing unit 130 according to the present embodiment calculates an amount of motion based on a spatial gradient obtained by the spatial differentiation in step S102 and a temporal gradient obtained by the temporal differentiation in step S103 (S104).

Next, based on the result of the target object detection in step S101 and the result of the motion amount calculation in step S104 (S105), the tracking processing unit 130 according to the present embodiment performs a cumulative calculation of tracked position, and outputs position data 19 after tracking.

According to the information processing method as described above, the temporal differentiation in step S103, the motion amount calculation in step S104, and the cumulative calculation of tracked position in step S105 can be performed at the frame rate (1 kHz) of the EVS image 12.

In addition, according to the information processing method described above, it is possible to respond to, for example, large motions of the target object by capturing time changes based on the EVS image 12 with a high frame rate, and it is also possible to respond to small motions that are difficult to track using the EVS image 12 alone by using the RGB image 11.

However, since the RGB image 11 and the EVS image 12 differ greatly in their data features, it is expected that the tracking accuracy may be reduced when a spatial gradient is calculated based on the RGB image 11 itself.

Therefore, the tracking processing unit 130 according to the present embodiment may calculate a spatial gradient based on an approximate image 13 obtained by approximating the RGB image 11 (an example of a first image) to the EVS image 12 (an example of a second image).

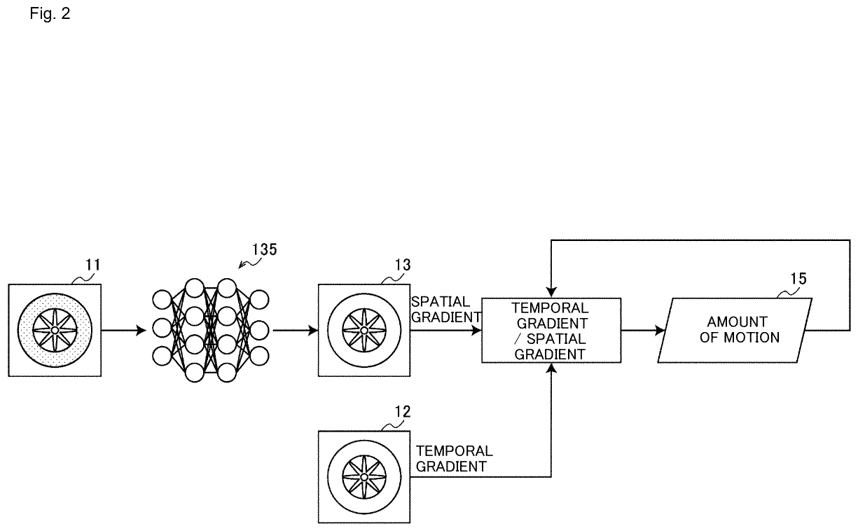

For this purpose, the tracking processing unit 130 according to the present embodiment may include an estimator 135 (see FIG. 2) that receives the first image as an input and outputs the approximate image 13.

FIG. 2 is a diagram schematically illustrating a motion amount calculation using the approximate image 13 according to the embodiment. In FIG. 2, an example is illustrated in which the target object is a tire of a vehicle.

As illustrated in FIG. 2, the tracking processing unit 130 according to the present embodiment inputs the RGB image 11 to the estimator 135, and calculates a spatial gradient based on the approximate image 13 output by the estimator 135.

The tracking processing unit 130 according to the present embodiment also calculates a temporal gradient based on the EVS image.

In addition, the tracking processing unit 130 according to the present embodiment calculates an amount of motion 15 based on the spatial gradient and the temporal gradient, which are calculated as described above.

According to the information processing method as described above, the calculation of the amount of motion 15 and the cumulative calculation of tracked position based on the amount of motion 15 can be processed at the frame rate of the EVS image 12, and the difference in data features between the RGB image 11 and the EVS image 12 can be absorbed, making it possible to achieve more accurate tracking.

### 1.2. Functional Configuration Example of Information Processing Device 10

Next, a functional configuration example of the information processing device 10 according to the present embodiment will be described. FIG. 3 is a block diagram illustrating the functional configuration example of the information processing device 10 according to the present embodiment.

As illustrated in FIG. 3, the information processing device 10 according to the present embodiment may include the RGB sensor 110, the EVS 120, the tracking processing unit 130, and an application processing unit 140.

### (RGB Sensor 110)

The RGB sensor 110 according to the present embodiment is an example of a first sensor that acquires the first image.

### (EVS 120)

The EVS 120 according to the present embodiment is an example of a second sensor that acquires the second image.

### (Tracking Processing Unit 130)

The tracking processing unit 130 according to the present embodiment detects and tracks a predetermined target object based on the RGB images 11 acquired in a time series by the RGB sensor 110 and the EVS images acquired in a time series by the EVS 120.

The tracking processing unit 130 according to the embodiment of the present embodiment has one feature that detects the target object based on the RGB image 11, calculates an amount of motion of the target object based on a spatial gradient derived from the RGB image 11 and a temporal gradient derived from the EVS image 12, and tracks the target object based on the amount of motion.

The functions of the tracking processing unit 130 according to the present embodiment are implemented by various types of processors. Details of the functions of the tracking processing unit 130 according to the present embodiment will be described later.

### (Application Processing Unit 140)

The application processing unit 140 according to the present embodiment controls an application based on the result of tracking the target object by the tracking processing unit 130.

The functions of the application processing unit 140 according to the present embodiment are implemented by various types of processors. Specific examples of the above application will be described later.

The functional configuration example of the information processing device 10 according to the embodiment has been described above. The above-mentioned functional configuration described with reference to FIG. 3 is merely an example, and the functional configuration of the information processing device 10 according to the embodiment is not limited to such a configuration.

For example, the information processing device 10 according to the present embodiment may further include an operation unit that receives operations from a user, and a display unit 150 that displays various types of information.

Each of the components illustrated in FIG. 3 does not necessarily have to be provided in a single device. For example, the tracking processing unit 130 and the application processing unit 140 may be provided in a server located in a cloud, and receive images from the RGB sensor 110 and the EVS 120 installed locally via a network.

As described above, the first image and the second image according to the present embodiment are not limited to an RGB image 11 and an EVS image, respectively.

The tracking processing unit 130 according to the present embodiment may track the target object using, for example, a LIDAR image, a ToF image, or the like.

The functional configuration of the information processing device 10 according to the present embodiment can be modified in a flexible manner according to the specifications and operations.

### 1.3. Details of Tracking Processing

Next, the processing of tracking a target object according to the present embodiment will be described in detail. As described above, the tracking processing unit 130 according to the present embodiment achieves low-delay, high-accuracy object tracking using the low noise RGB image 11 and the high frame rate EVS image 12.

In response to the RGB image 11 and the EVS image 12 as inputs, the tracking processing unit 130 according to the present embodiment can output the coordinates (u, v) of the center position of a target object in the images every frame at the frame rate of the EVS image.

However, the RGB image 11 and the EVS image 12 differ greatly in both their frame rate and data features.

For this reason, the tracking processing unit 130 according to the present embodiment absorbs that difference by obtaining an approximate image 13 from the RGB image 11 using the estimator 135 generated by supervised learning, which will be described later.

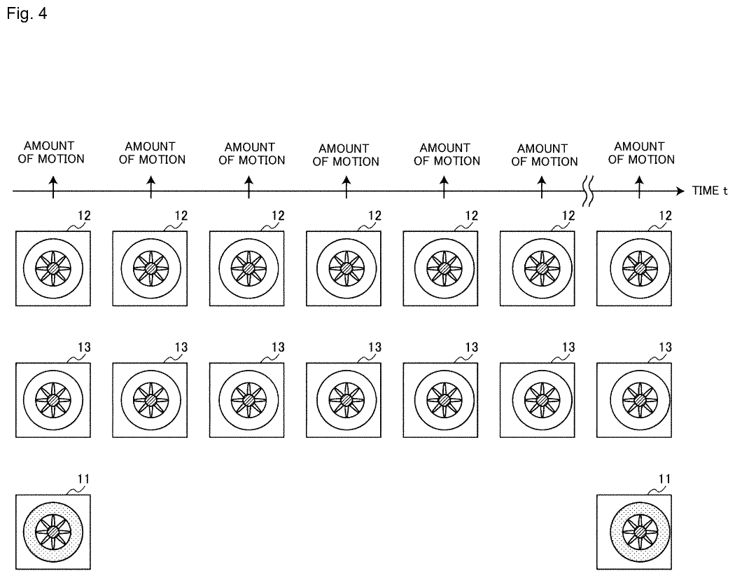

FIG. 4 is a diagram for explaining an overview of time-series image processing according to the present embodiment. In FIG. 4, the target object is a tire of a vehicle, and the center position of the tire is highlighted by hatching.

As illustrated in FIG. 4, the RGB sensor 110 acquires RGB images 11 as time t passes. Similarly, the EVS 120 acquires EVS images 12 as time t passes.

Since the RGB image 11 is acquired at a lower frame rate than the EVS image 12, in order to calculate an amount of motion for each frame rate of the EVS image 12, it is necessary to interpolate data from periods when the RGB image 11 is not acquired.

Therefore, the tracking processing unit 130 according to the present embodiment may generate an approximate image 13 using the estimator 135 generated by supervised learning to approximate the RGB image 11 to the EVS image 12, and calculate a spatial gradient based on the approximate image 13.

According to the information processing method as described above, it is possible to calculate an amount of motion with high accuracy for each frame rate of the EVS image 12 by using the temporal gradient calculated based on the EVS image 12 and the spatial gradient calculated based on the approximate image 13.

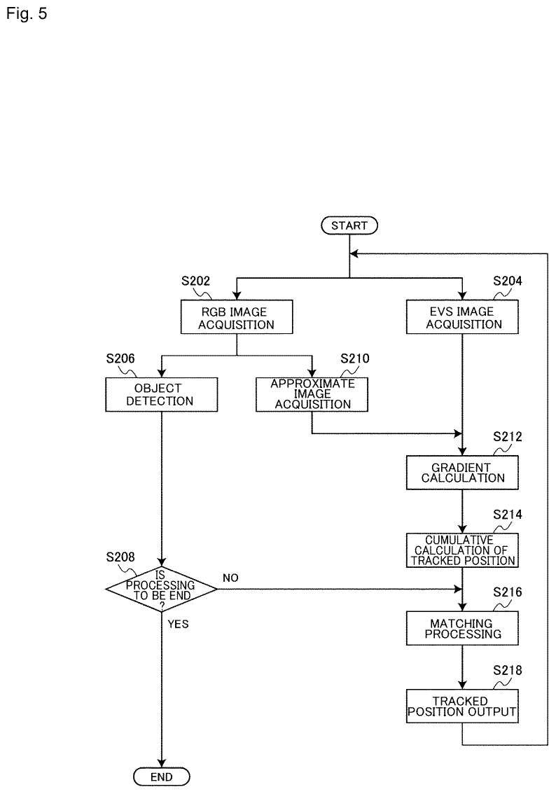

Next, the flow of the tracking processing according to the present embodiment will be described in more detail. FIG. 5 is a flowchart illustrating an example of the flow of the tracking processing according to the present embodiment.

In the case of the example illustrated in FIG. 5, first, the RGB sensor 110 acquires an RGB image 11 (S202), and the EVS 120 acquires an EVS image 12 (S204).

The tracking processing unit 130 detects the target object based on the RGB image 11 acquired in step S202, and obtains the coordinates (u, v) of the center position of the target object (S206).

Next, the tracking processing unit 130 determines whether or not to end the series of processing (S208). The tracking processing unit 130 may make the above determination based on, for example, whether or not a predetermined end condition has been satisfied, or whether or not an instruction to end the processing has been given by the user.

If the tracking processing unit 130 determines that the processing is to be ended (S208: YES), the tracking processing unit 130 ends the series of processing, and if the tracking processing unit 130 determines that the processing is not to be ended (S208: NO), the tracking processing unit 130 continues the series of processing.

If the processing is not to be ended, the coordinates (u, v) of the center position of the target object acquired in step S206 are used in matching processing in step S216, which will be described later.

The tracking processing unit 130 also inputs the RGB image 11 acquired in step S202 to the estimator 135 to obtain an approximate image 13 (S210).

Next, the tracking processing unit 130 performs a gradient calculation based on the EVS image 12 acquired in step S204 and the approximate image 13 acquired in step S210 (S212).

Specifically, the tracking processing unit 130 calculates a temporal gradient based on the EVS image 12 acquired in step S204, calculates a spatial gradient from the approximate image acquired in step S210, and calculates an amount of motion based on the temporal gradient and the spatial gradient.

First, general gradient calculation formulas will be described. The general gradient calculation formulas can be set as follows:

$$\begin{matrix}Ix ( u , v , t ) = I ( u + 1 , v , t ) - I ( u - 1 , v , t ) \\ Iy ( u , v , t ) = I ( u , v + 1 , t ) - I ( u , v - 1 , t ) \\ It ( u , v , t ) = I ( u , v , t ) - I ( u , v , t - 1 )\end{matrix}$$

In the above gradient calculation formulas, I represents an RGB image, u represents a U coordinate, v represents a V coordinate, and t represents the time (frame number). In addition, Ix represents a spatial gradient on the x-axis (spatial horizontal axis), Iy represents a spatial gradient on the y-axis (spatial vertical axis), and It represents a temporal gradient on the t-axis (time axis).

Next, the surrounding pixels are combined to create an estimation equation represented in the following Equation (1).

$$[ Math . 1 ]$$

$$( \begin{matrix}Ix ( u , v ) & Iy ( u , v ) \\ ⋮ & ⋮ \\ Ix ( {u}^{′} , {v}^{′} ) & Iy ( {u}^{′} , {v}^{′} )\end{matrix} ) ( \begin{matrix}du \\ dv\end{matrix} ) = ( \begin{matrix}It ( u , v ) \\ ⋮ \\ It ( {u}^{′} , {v}^{′} )\end{matrix} ) \qquad ( 1 )$$

Equation (1) is summarized as the following Equation (2), and by solving the least squares, the following Equation (3) is obtained.

$$[ Math . 2 ]$$

$$A ( \begin{matrix}du \\ dv\end{matrix} ) = b \qquad ( 2 )$$

$$( \begin{matrix}du \\ dv\end{matrix} ) = {( {A}^{T} A )}^{- 1} Ab \qquad ( 3 )$$

The tracking processing unit 130 according to the present embodiment replaces I with the EVS image 12 in the calculation of Ix, and replaces I with the approximate image 13 in the calculations of Iy and It, and obtains an amount of motion (du, dv) by solving Equation (3).

First, the calculation of replacing I with the EVS image 12 in the calculation of It will be described. As described above, the EVS image 12 and the RGB image 11 differ greatly in their frame rate. For this reason, when I is replaced with the EVS image 12 in the calculation of It, it is necessary to perform the calculation while ensuring the changes in It and Ix Iy. Accordingly, their formulas are set as follows:

$$\begin{matrix}Ix ( u , v , t + α ) = EVS ( u , v , t + α ) \\ Iy ( u , v , t + α ) = Ix ( u + {du}^{′} , v + {dv}^{′} , t ) \\ It ( u , v , t + α ) = Iy ( u , {du}^{′} , v + {dv}^{′} , t )\end{matrix}$$

In the above formulas, a represents a very small time. Further, du′ and dv′ represent amounts of motion from time t to time t+α. Further, EVS represents the EVS image 12. The amount of motion (du, dv) obtained by the above formulas is used in the next calculations of Ix and Iy.

Here, as described above, since the RGB image 11 and the EVS image 12 differ greatly in their data features, the tracking processing unit 130 replaces I with the approximate image 13 in the calculations of Ix and Iy in order to perform tracking with higher accuracy. In this case, the gradient calculation formulas are represented as follows:

$$\begin{matrix}It ( u , v , t + α ) = EVS ( u , v , t + α ) \\ Ix ( u , v , t + α ) = DNN ( u + {du}^{′} , v + {dv}^{′} , t ) \\ Iy ( u , v , t + α ) = DNN ( u , {du}^{′} , v + {dv}^{′} , t )\end{matrix}$$

In the above formulas, DNN represents the approximate image 13.

The gradient calculation by the tracking processing unit 130 according to the present embodiment has been described above.

The tracking processing unit 130 performs the cumulative calculation for the tracked position of the target object based on the amount of motion (du, dv) calculated in step S212 as described above, and obtains the coordinates (u, v) of the center position of the target object (S214).

Next, the tracking processing unit 130 compares the coordinates (u, v) of the center position of the target object detected in step S206 with the coordinates (u, v) of the center position of the target object obtained in step S214, and performs matching processing as necessary (S216).

After step S216, the tracking processing unit 130 outputs the final tracked position (the coordinates (u, v) of the center position of the target object) in the corresponding frame (S218). That tracked position is also used in the gradient calculation in step S212 and the cumulative calculation for the tracked position of the target object in step S214.

### 1.4. Details of Learning

Next, a learning method according to the present embodiment will be described in detail. The estimator 135 according to the present embodiment may be generated by supervised learning to reduce the difference between the amount of motion calculated from the temporal gradient based on the approximate image 13 and the temporal gradient based on the second image, and a given correct amount of motion.

The estimator 135 according to the present embodiment may be, for example, a deep neural network (hereinafter, referred to as DNN) having a differentiable or linearly operable loss function.

Since Equation (3) is for a linear matrix calculation, given the correct amount of motion (dugt, dvgt) serving as a teacher, the parameters for the DNN can be learned.

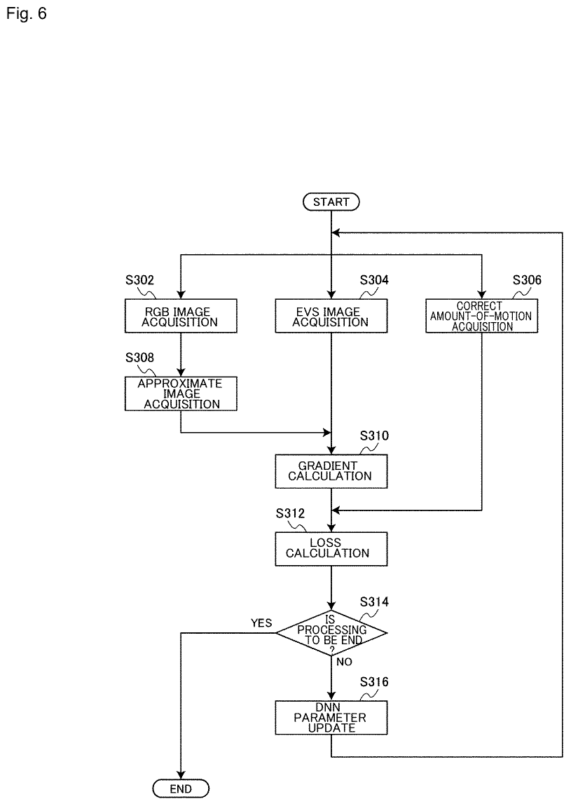

FIG. 6 is a flowchart illustrating an example of a flow of learning according to the present embodiment.

In the case of the example illustrated in FIG. 6, first, the RGB sensor 110 acquires an RGB image 11 (S302). The EVS 120 acquires an EVS image 12 (S304). In addition, a correct amount of motion (dugt, dvgt) is given based on, for example, an operation from the user (S306).

The tracking processing unit 130 (or other components for learning) inputs the RGB image 11 acquired in step S302 to the estimator 135 to acquire an approximate image 13 (S308). Specifically, the tracking processing unit 130 obtains an approximate image 13 by subjecting the RGB image 11 to DNN filtering.

Next, the tracking processing unit 130 performs a calculation of a spatial gradient based on the approximate image 13 acquired in step S308 and a calculation of a temporal gradient based on the EVS image 12 acquired in step S304, and calculates an amount of motion (du, dv) based on the calculated spatial gradient and temporal gradient (S310).

Next, the tracking processing unit 130 calculates a loss based on the amount of motion (du, dv) calculated in step S310 and the correct amount of motion (dugt, dvgt) acquired in step S306 (S312).

Next, the tracking processing unit 130 determines whether or not to end the learning (S314). The tracking processing unit 130 may make the above determination based on, for example, whether or not a predetermined end condition has been satisfied, or whether or not an instruction to end the processing has been given by the user.

If the tracking processing unit 130 determines that the learning is to be ended (S314: YES), the tracking processing unit 130 ends the series of processing for the learning.

On the other hand, if the tracking processing unit 130 determines not to end the learning (S314: NO), the tracking processing unit 130 updates the parameters for the DNN based on the loss calculated in step S312 and proceeds to the next learning cycle.

An example of the flow of the learning method according to the present embodiment has been described above. According to the learning method as described above, it is possible to achieve efficient learning that brings the amount of motion (du, dv) obtained as a result of gradient calculation closer to the correct amount of motion (dugt, dvgt).

### 1.5. Application Examples

Next, an example will be described in which the result of the tracking processing according to the present embodiment is used in an application.

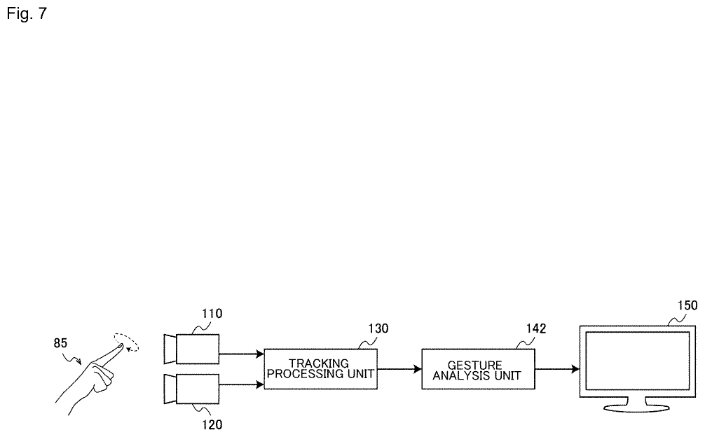

For example, the result of the tracking processing according to the present embodiment may be used for gesture analysis in an NUI. FIG. 7 is a diagram for explaining a configuration in the case where the result of the tracking processing according to the present embodiment is used for gesture analysis in the NUI.

In this example, the target object may be, for example, a hand 85 of the user. The tracking processing unit 130 performs tracking processing based on the RGB image 11 acquired by the RGB sensor 110 and the EVS image 12 acquired by the EVS 120, which are of the hand 85 of the user as the subject, and outputs the result to a gesture analysis unit 142.

The gesture analysis unit 142 is an example of the application processing unit 140 described above. The gesture analysis unit 142 analyzes the gesture made by the hand 85 of the user based on the result of the tracking processing output from the tracking processing unit 130.

The gesture analysis unit 142 may also control, for example, icons displayed on the display unit 150 based on the result of the gesture analysis.

According to the low-latency, high-accuracy tracking processing according to the present embodiment, it is possible to respond to, for example, a wide range of gestures involving large motions, and also makes it possible to control the NUI quickly and with high accuracy based on the result of gesture analysis.

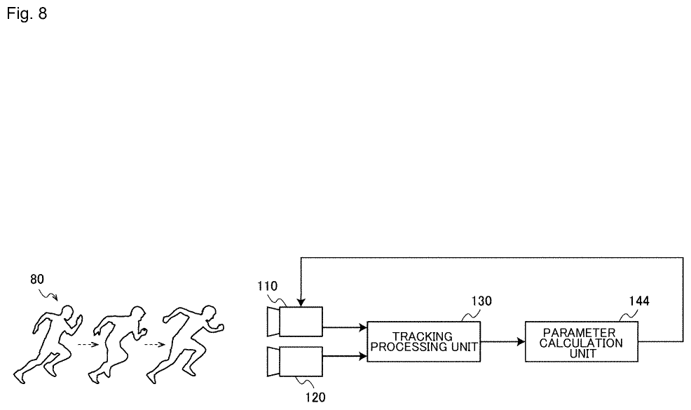

For example, the result of the tracking processing according to the present embodiment may be used to calculate parameters for the acquisition of the first image. FIG. 8 is a diagram for explaining a configuration in the case where a result of the tracking processing according to the present embodiment is used for calculation of parameters for the acquisition of an RGB image 11.

In this example, the target object may be a moving object such as a user 80 making large motions. The tracking processing unit 130 performs tracking processing based on the RGB image 11 acquired by the RGB sensor 110 and an EVS image 12 acquired by the EVS 120, which are, for example, of the user 80 as the subject, and outputs the result to a parameter calculation unit 144.

The parameter calculation unit 144 is an example of the application processing unit 140 described above. The parameter calculation unit 144 calculates parameters suitable for the acquisition of the RGB image 11 based on the result of the tracking processing output from the tracking processing unit 130.

The parameters include, for example, an aperture value, a shutter speed, an ISO sensitivity, and a white balance.

The parameter calculation unit 144 outputs the values of the calculated parameters as described above to the RGB sensor 110.

By using the result of the low-latency, high-accuracy tracking processing according to the present embodiment to calculate the parameters as described above, for example, the focus can be automatically adjusted so that the target object is in focus, making it possible to achieve high-quality imaging without losing focus, even for a target object that moves at high speed or for a target object that is located far away.

### 1.6. Modification Example of Sensor

Next, a modification example of the sensor according to the present embodiment will be described. In the above description, a case has been described as an example, in which the information processing device 10 is mainly provided with the RGB sensor 110 that captures the RGB image 11 and the EVS 120 that acquires the EVS image 12, which are separate components.

On the other hand, the RGB image 11 and the EVS image according to the present embodiment may be acquired by a single sensor. In other words, the RGB sensor 110 and the EVS 120 according to the present embodiment may be integrally formed.

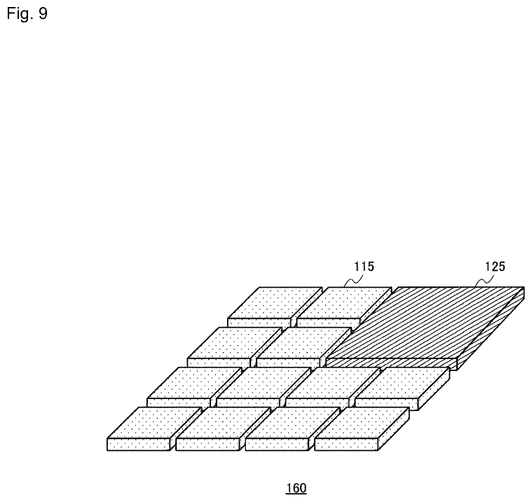

FIG. 9 is a diagram for explaining a structure of a 2-in-1 sensor 160 according to the present embodiment. As illustrated in FIG. 9, the 2-in-1 sensor 160 according to the present embodiment may have a structure in which RGB pixels 115 and an EVS pixel 125 are arranged side by side on a substrate.

With such a structure, the optical axes for the acquisition of the RGB image 11 and the EVS image are automatically aligned, making it possible to eliminate occlusion and phase shift that are caused by parallax between the sensors that may occur in the case where the RGB sensor 110 and the EVS 120 are separate components.

### 2. HARDWARE CONFIGURATION EXAMPLE

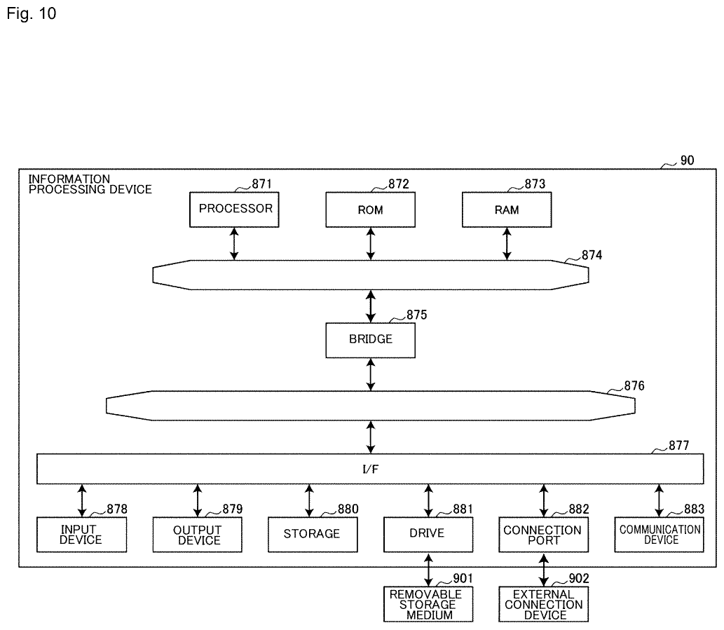

Next, a hardware configuration example of the information processing device 10 according to an embodiment of the present disclosure will be described. FIG. 10 is a block diagram illustrating a hardware configuration example of an information processing device 90 according to an embodiment of the present disclosure. The information processing device 90 may be a device having the same hardware configuration as the information processing device 10.

As illustrated in FIG. 10, the information processing device 90 includes, for example, a processor 871, a ROM 872, a RAM 873, a host bus 874, a bridge 875, an external bus 876, an interface 877, an input device 878, an output device 879, a storage 880, a drive 881, a connection port 882, and a communication device 883. The hardware configuration illustrated herein is an example, and some of the components may be omitted. Further, components other than the components illustrated herein may be further included.

### (Processor 871)

The processor 871 functions as, for example, an arithmetic processing device or a control device, and controls all or some of the operations of the components on the basis of various types of programs recorded in the ROM 872, the RAM 873, the storage 880, or a removable storage medium 901.

### (ROM 872, RAM 873)

The ROM 872 is a means for storing a program read into the processor 871, data used for computation, and the like. In the RAM 873, for example, a program read into the processor 871, various types of parameters that change as appropriate when the program is executed, and the like are temporarily or permanently stored.

### (Host Bus 874, Bridge 875, External Bus 876, Interface 877)

The processors 871, the ROM 872, and the RAM 873 are connected to each other via, for example, the host bus 874 capable of high-speed data transmission. On the other hand, the host bus 874 is connected to the external bus 876 with a relatively low data transmission speed via, for example, the bridge 875. The external bus 876 is connected to various components via the interface 877.

### (Input Device 878)

For the input device 878, for example, a mouse, a keyboard, a touch panel, buttons, switches, levers, and the like are used. As the input device 878, a remote controller capable of transmitting a control signal using infrared rays or other radio waves may be used. The input device 878 also includes a voice input device such as a microphone.

### (Output Device 879)

The output device 879 is, for example, a device capable of notifying the user of acquired information visually or audibly, such as a display device such as a CRT (Cathode Ray Tube), an LCD, or an organic EL, an audio output device such as a speaker or a headphone, a printer, a mobile phone, a facsimile, or the like. The output device 879 according to the present disclosure includes various types of vibration devices capable of outputting tactile stimuli.

### (Storage 880)

The storage 880 is a device for storing various types of data. As the storage 880, for example, a magnetic storage device such as a hard disk drive (HDD), a semiconductor storage device, an optical storage device, a magneto-optical storage device, or the like is used.

### (Drive 881)

The drive 881 is a device that reads information recorded on the removable storage medium 901 such as a magnetic disk, an optical disk, a magneto-optical disk, or a semiconductor memory, or writes information to the removable storage medium 901.

### (Removable Storage Medium 901)

The removable storage medium 901 is, for example, a DVD medium, a Blu-ray (registered trademark) medium, an HD DVD medium, various semiconductor storage media, or the like. Naturally, the removable storage medium 901 may be, for example, an IC card equipped with a non-contact type IC chip, an electronic device, or the like.

### (Connection Port 882)

The connection port 882 is a port for connecting an external connection device 902 such as a Universal Serial Bus (USB) port, an IEEE1394 port, a Small Computer System Interface (SCSI), an RS-232C port, or an optical audio terminal.

### (External Connection Device 902)

The external connection device 902 is, for example, a printer, a portable music player, a digital camera, a digital video camera, an IC recorder, or the like.

### (Communication Device 883)

The communication device 883 is a communication device for connecting to a network, and is, for example, a communication card for wired or wireless LAN, Bluetooth (registered trademark), or Wireless USB (WUSB), a router for optical communication, a router for Asymmetric Digital Subscriber Line (ADSL), or a modem for various types of communications.

### 3. CONCLUSION

As described above, the information processing device 10 according to an embodiment of the present disclosure includes a tracking processing unit 130 that detects and tracks a target object based on a first image and a second image that are acquired in a time series.

The tracking processing unit 130 according to the embodiment of the present disclosure has one feature that detects the target object based on the first image, calculates an amount of motion of the target object based on a spatial gradient derived from the first image and a temporal gradient derived from the second image, and tracks the target object based on the amount of motion.

Another feature is that the second image is acquired at a frame rate higher than a frame rate of the first image.

With the above configuration, it is possible to achieve low latency, high-accuracy object tracking.

Although the preferred embodiments of the present disclosure have been described in detail with reference to the accompanying drawings as described above, the technical scope of the present disclosure is not limited to such examples. It is apparent that those having ordinary knowledge in the technical field of the present disclosure could conceive various modification examples or changed examples within the scope of the technical ideas set forth in the claims, and it should be understood that these also naturally fall within the technical scope of the present disclosure.

The steps related to the processing described in the present disclosure do not necessarily have to be processed in chronological order in the flowcharts or the sequence diagrams. For example, the steps related to the processing of each device may be processed in an order different from the order described, or may be processed in parallel.

The series of processing performed by each device described in the present disclosure may be implemented by a program stored in a non-transitory computer readable storage medium. Each program is, for example, read into a RAM when executed by a computer, and executed by a processor such as a CPU. The storage medium is, for example, a magnetic disk, an optical disk, a magneto-optical disk, or a flash memory. Further, the above computer program may be distributed via, for example, a network without using the storage medium.

Further, the effects described herein are merely explanatory or exemplary and are not intended as limiting. In other words, the technologies according to the present disclosure may exhibit other effects apparent to those skilled in the art from the description herein, in addition to or in place of the above effects.

The following configurations also fall within the technical scope of the present disclosure.

(1)

An information processing device including a tracking processing unit that detects and tracks a target object based on a first image and a second image that are acquired in a time series,
wherein
the tracking processing unit detects the target object based on the first image, calculates an amount of motion of the target object based on a spatial gradient derived from the first image and a temporal gradient derived from the second image, and tracks the target object based on the amount of motion, and
the second image is acquired at a frame rate higher than a frame rate of the first image.
   (2)

The information processing device according to (1), wherein the tracking processing unit calculates the spatial gradient based on an approximate image obtained by approximating the first image to the second image.

(3)

The information processing device according to (2), wherein the tracking processing unit includes an estimator that receives the first image as an input and outputs the approximate image.

(4)

The information processing device according to (3), wherein the estimator is generated by supervised learning to reduce the difference between the amount of motion calculated from the temporal gradient based on the approximate image and the temporal gradient based on the second image, and a given correct amount of motion.

(5)

The information processing device according to any one of (1) to (4), wherein the second image is acquired by an EVS.

(6)

The information processing device according to (5), wherein the first image is acquired by an RGB sensor.

(7)

The information processing device according to (6), further including the EVS.

(8)

The information processing device according to (7), further including the RGB sensor.

(9)

The information processing device according to (8), wherein the EVS and the RGB sensor are integrally formed.

(10)

The information processing device according to any one of (1) to (9), further including an application processing unit that controls an application based on a result of tracking the target object by the tracking processing unit.

(11)

The information processing device according to (10), wherein the application processing unit performs gesture analysis based on a result of tracking the target object.

(12)

The information processing device according to (10), wherein the application processing unit calculates parameters for acquisition of the first image based on a result of tracking the target object.

(13)

The information processing device according to (12), wherein the parameters include an aperture value.

(14)

An information processing method including detecting and tracking, by a processor, a target object based on a first image and a second image that are acquired in a time series,
wherein
the tracking further includes detecting the target object based on the first image, calculating an amount of motion of the target object based on a spatial gradient derived from the first image and a temporal gradient derived from the second image, and tracking the target object based on the amount of motion, and
the second image is acquired at a frame rate higher than a frame rate of the first image.
   (15)

A program causing a computer to function as an information processing device including
a tracking processing unit that detects and tracks a target object based on a first image and a second image that are acquired in a time series,
wherein
the tracking processing unit detects the target object based on the first image, calculates an amount of motion of the target object based on a spatial gradient derived from the first image and a temporal gradient derived from the second image, and tracks the target object based on the amount of motion, and
the second image is acquired at a frame rate higher than a frame rate of the first image.

### REFERENCE SIGNS LIST

10 Information processing device
11 RGB image
12 EVS image
13 Approximate image
110 RGB sensor
120 EVS
130 Tracking processing unit
135 Estimator
140 Application processing unit
142 Gesture analysis unit
144 Parameter calculation unit

1. An information processing device comprising a tracking processing unit that detects and tracks a target object based on a first image and a second image that are acquired in a time series,
wherein
the tracking processing unit detects the target object based on the first image, calculates an amount of motion of the target object based on a spatial gradient derived from the first image and a temporal gradient derived from the second image, and tracks the target object based on the amount of motion, and
the second image is acquired at a frame rate higher than a frame rate of the first image.

2. The information processing device according to claim 1, wherein the tracking processing unit calculates the spatial gradient based on an approximate image obtained by approximating the first image to the second image.

3. The information processing device according to claim 2, wherein the tracking processing unit includes an estimator that receives the first image as an input and outputs the approximate image.

4. The information processing device according to claim 3, wherein the estimator is generated by supervised learning to reduce the difference between the amount of motion calculated from the temporal gradient based on the approximate image and the temporal gradient based on the second image, and a given correct amount of motion.

5. The information processing device according to claim 1, wherein the second image is acquired by an EVS.

6. The information processing device according to claim 5, wherein the first image is acquired by an RGB sensor.

7. The information processing device according to claim 6, further comprising the EVS.

8. The information processing device according to claim 7, further comprising the RGB sensor.

9. The information processing device according to claim 8, wherein the EVS and the RGB sensor are integrally formed.

10. The information processing device according to claim 1, further comprising an application processing unit that controls an application based on a result of tracking the target object by the tracking processing unit.

11. The information processing device according to claim 10, wherein the application processing unit performs gesture analysis based on a result of tracking the target object.

12. The information processing device according to claim 10, wherein the application processing unit calculates parameters for acquisition of the first image based on a result of tracking the target object.

13. The information processing device according to claim 12, wherein the parameters include an aperture value.

14. An information processing method comprising detecting and tracking, by a processor, a target object based on a first image and a second image that are acquired in a time series,
wherein
the tracking further includes detecting the target object based on the first image, calculating an amount of motion of the target object based on a spatial gradient derived from the first image and a temporal gradient derived from the second image, and tracking the target object based on the amount of motion, and
the second image is acquired at a frame rate higher than a frame rate of the first image.

15. A program causing a computer to function as an information processing device comprising
a tracking processing unit that detects and tracks a target object based on a first image and a second image that are acquired in a time series,
wherein
the tracking processing unit detects the target object based on the first image, calculates an amount of motion of the target object based on a spatial gradient derived from the first image and a temporal gradient derived from the second image, and tracks the target object based on the amount of motion, and
the second image is acquired at a frame rate higher than a frame rate of the first image.
